(19) United States
(12) Patent Application Publication
(10) Pub. No.: US 2024/0215572 A1
(43) Pub. Date: Jul. 4, 2024

(54) ANTIMICROBIAL PARTICLE DISPERSION

(71) Applicant: MITSUBISHI PENCIL COMPANY, LIMITED, Shinagawa-ku (JP)

(72) Inventor: Hisato HAGA, Shinagawa-ku (JP)

(73) Assignee: MITSUBISHI PENCIL COMPANY, LIMITED, Shinagawa-ku (JP)

(21) Appl. No.: 18/558,081

(22) PCT Filed: Mar. 25, 2022
(86) PCT No.: PCT/JP2022/014224

§ 371 Date: Oct. 30, 2023

(30) Foreign Application Priority Data
Jun. 21, 2021 (JP) 2021-102596
Jul. 21, 2021 (JP) 2021-120846

(51) Int. Cl. A01N 25/04; A01N 31/02; A01P 1/00; C09D 11/18

(52) U.S. Cl. CPC A01N 25/04; A01N 31/02; A01P 1/00; C09D 11/18

(57) ABSTRACT

An antimicrobial particle dispersion may have high safety, a wide antibacterial spectrum, and excellent stability and antimicrobial effect (including an antifungal effect). Such an antimicrobial particle dispersion may including antimicrobial particles dispersed in water, the antimicrobial particles containing: (i) at least a (meth)acrylate monomer of formula (I):

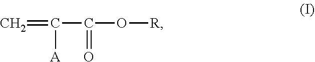

A being H or CH₃, and R being H, an alkyl group having 1 to 22 carbon atoms, or a substituent having a polyalkylene glycol chain in which the alkylene chain has 2 to 18 carbon atoms; and (ii) at least one antimicrobial component selected from an iodopropargyl compound, thiabendazole, p-oxybenzoic acid ester, sodium benzoate, and the like.

### TECHNICAL FIELD

The present specification relates to an antimicrobial particle dispersion which is excellent in an antimicrobial effect (including an antifungal effect) of an antimicrobial component even after a long period of time and is excellent in safety and stability.

### BACKGROUND ART

In the related art, some materials are known as antimicrobial particles and the like.

For example, there are known: (1) an antibiotic active particle in which an antibiotic active compound is dispersed in a polymer containing an epoxy group, the polymer being obtained by dispersing a hydrophobic solution containing a monomer component containing an epoxy group-containing monomer and the antibiotic active compound in water and polymerizing the monomer component (see, for example, Patent Document 1);

(2) an antimicrobial resin for a cosmetic product, the antimicrobial resin containing an inorganic antimicrobial agent and including spherical particles having an average particle size of 0.1 m to 1000 μm, in which the inorganic antimicrobial agent obtained by causing at least one ceramic selected from the group consisting of alumina, silica, zeolite, a phosphate-based compound, calcium carbonate, calcium silicate, bentonite, and titanium oxide to support at least one antimicrobial metal selected from the group consisting of silver, copper, zinc, gold, platinum, and nickel is used (for example, see Patent Document 2);

(3) porous resin fine particles including a crosslinked (meth)acrylate-based resin, the porous resin fine particles having a compression strength of 0.05 to 0.6 kgf/mm² and a recovery rate of 3 to 40% when a load is reduced from 1 gf to 0.2 gf (for example, see Patent Document 3); and

(4) sustained-release particles obtained by a production method including an oil phase component preparation process of preparing an oil phase component containing a hydrophobic slurry by dispersing, in a hydrophobic polymerizable vinyl monomer, an antibiotic active compound which is hydrophobic and substantially insoluble in the hydrophobic polymerizable vinyl monomer in the absence of a solvent, a water dispersion process of preparing an aqueous dispersion by dispersing the oil phase component in water, and a polymerization process of subjecting the polymerizable vinyl monomer to suspension polymerization to form a polymer (for example, see Patent Document 4).

However, the antimicrobial particles and the like described in Patent Documents 1 to 4 have problems such as insufficient stability and safety, loss of the antimicrobial effect (including antifungal effect) of the antimicrobial component after a long period of time, and some adverse effects on other blended components. Thus, an antimicrobial particle dispersion having further stability and safety, excelling in the antimicrobial effect (including the antifungal effect) of the antimicrobial component even after a long period of time, and having no adverse effect on other blended components is strongly desired.

### CITATION LIST

### Patent Document

Patent Document 1: JP 2014-31365 A (Claims, Examples, and the like)
Patent Document 2: WO 2002/030365 A1 (Claims, Examples, and the like)
Patent Document 3: JP 2002-265529 A (Claims, Examples, and the like)
Patent Document 4: JP 2016-6023 A (Claims, Examples, and the like)

### SUMMARY OF INVENTION

### Technical Problem

In view of the problems in the related art described above, the present disclosure is to solve the problems, and directed to providing an antimicrobial particle dispersion and the like which have high stability and safety, are excellent in antimicrobial effect (including antifungal effect) of an antimicrobial component after a long period of time, and do not affect other blended components.

### Solution to Problem

The inventor of the present invention has conducted intensive research in view of the above-described problems. As a result, he has found that the antimicrobial particle dispersion of the above-described object can be obtained by dispersing antimicrobial particles containing at least a (meth)acrylate monomer represented by a specific formula and a specific antimicrobial component in water, and thus has completed the present disclosure.

That is, the antimicrobial particle dispersion of the present disclosure is an antimicrobial particle dispersion in water, comprising at least antimicrobial particles containing at least a (meth)acrylate monomer represented by the following general formula (I) and an antimicrobial component being selected from the following group A are dispersed in water.

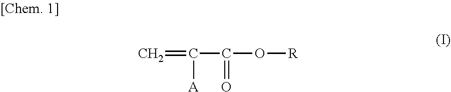

[In the above formula (I), A represents a hydrogen atom (H) or a methyl group (CH₃), and R represents a hydrogen atom (H), an alkyl group having 1 to 22 carbon atoms, or a substituent having a polyalkylene glycol chain in which the alkylene chain has 2 to 18 carbon atoms, and the alkyl group or the substituent having a polyalkylene glycol chain represents, as a substituent, a phenyl group, a benzyl group, an epoxy group, a hydroxyl group, a dialkylamino group, an alkoxy group having 1 to 18 carbon atoms, a perfluoroalkyl group having 1 to 18 carbon atoms, or a trialkoxysilyl group.]

Group A: an iodopropargyl compound, thiabendazole, sodium pentachlorophenol, 1,2-benzisothiazolin-3-one, 2,3,5,6-tetrachloro-4 (methylsulfonyl)pyridine, paraoxybenzoic acid ester, phenol, sodium benzoate, sodium dehydroacetate, potassium sorbate, morpholine, cresol, methylisothiazolinone, chloromethylisothiazolinone, octylisothiazolinone, dichlorooctylisothiazolinone, hexahydro-1,3,5-tris(2-hydroxyethyl)-1,3,5-triazine, 2-bromo-2-nitropropane-1,3-diol, sodium 2-pyridinethiol-1-oxide, sodium pyrithione, 2-(4-thiozolyl)benzimidazole, 4-terpineol, 1,8-cineol, thymol, diisothiocyanate, eucalyptus oil, longifolene, isopropylmethylphenol, 2-methyl-4-isothiazolin-3-one, citral, eugenol, allylisothiocyanate, d-limonene, tannic acid, ethyl paraben, benzalkonium chloride, glycerylcaprylate, glycerin fatty acid ester, chlorphenesin, salicylic acid, ethyl paraoxybenzoate, butyl paraoxybenzoate, propyl paraoxybenzoate, methyl paraoxybenzoate, bisabolol, hinokitiol, phenylethyl alcohol, phenethyl alcohol, phenoxyethanol, butylparaben, propylparaben, benzalkonium chloride, methyl paraben

The content of the (meth)acrylate monomer represented by the general formula (I) is preferably 30 to 95 mass % based on a total of polymer components constituting the antimicrobial particle dispersion. The antimicrobial component is preferably contained in an amount of 1 mass % or more based on the total of polymer components constituting the antimicrobial particles.

The antimicrobial particles of the antimicrobial particle dispersion preferably have an average particle size of 10 to 800 nm.

The content of the antimicrobial particles is preferably 0.1 to 50 mass % based on a total amount of the antimicrobial particle dispersion.

An aqueous ink composition for a writing instrument of the present disclosure includes the antimicrobial particle dispersion.

### Advantageous Effects of Invention

According to the present disclosure, there are provided an antimicrobial particle dispersion which has high stability and safety, is excellent in an antimicrobial effect (including an antifungal effect) of an antimicrobial component after a long period of time, and does not affect other blended components, and an aqueous ink composition for a writing instrument containing the same.

The object and effects of the present disclosure can be recognized and obtained especially using the components and combinations indicated in the claims. Both the general explanation described above and the detailed explanation described below are exemplary and explanatory and do not limit the present disclosure described in Claims.

### DESCRIPTION OF EMBODIMENTS

Embodiments of the present disclosure will be described below in detail. However, note that the technical scope of the present disclosure is not limited to the embodiments described below and includes the invention described in Claims and equivalents thereof.

An antimicrobial particle dispersion of the present disclosure is an antimicrobial particle dispersion in which antimicrobial particles containing at least a (meth)acrylate monomer represented by the following general formula (I) and at least one antimicrobial component selected from the following group A are dispersed in water.

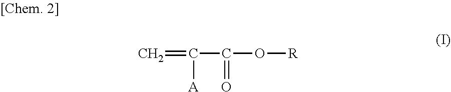

[In the above formula (I), A represents a hydrogen atom (H) or a methyl group (CH₃), and R represents a hydrogen atom (H), an alkyl group having 1 to 22 carbon atoms, or a substituent having a polyalkylene glycol chain in which the alkylene chain has 2 to 18 carbon atoms, and the alkyl group or the substituent having a polyalkylene glycol chain represents, as the substituent, a phenyl group, a benzyl group, an epoxy group, a hydroxyl group, a dialkylamino group, an alkoxy group having 1 to 18 carbon atoms, a perfluoroalkyl group having 1 to 18 carbon atoms, or a trialkoxysilyl group.]

Group A: an iodopropargyl compound, thiabendazole, sodium pentachlorophenol, 1,2-benzisothiazolin-3-one, 2,3,5,6-tetrachloro-4 (methylsulfonyl)pyridine, paraoxybenzoic acid ester, phenol, sodium benzoate, sodium dehydroacetate, potassium sorbate, morpholine, cresol, methylisothiazolinone, chloromethylisothiazolinone, octylisothiazolinone, dichlorooctylisothiazolinone, hexahydro-1,3,5-tris(2-hydroxyethyl)-1,3,5-triazine, 2-bromo-2-nitropropane-1,3-diol, sodium 2-pyridinethiol-1-oxide, sodium pyrithione, 2-(4-thiozolyl)benzimidazole, 4-terpineol, 1,8-cineol, thymol, diisothiocyanate, eucalyptus oil, longifolene, isopropylmethylphenol, 2-methyl-4-isothiazolin-3-one, citral, eugenol, allyl isothiocyanate, d-limonene, tannic acid, sodium benzoate, ethyl paraben, benzalkonium chloride, glyceryl caprylate, glycerin fatty acid ester, chlorphenesin, salicylic acid, ethyl paraoxybenzoate, butyl paraoxybenzoate, propyl paraoxybenzoate, methyl paraoxybenzoate, bisabolol, hinokitiol, phenylethyl alcohol, phenethyl alcohol, phenoxyethanol, butylparaben, propylparaben, benzalkonium chloride, methyl paraben

The antimicrobial component used in the present disclosure is at least one (each singly or in a mixture of two or more, the same applies hereinafter) selected from the group A consisting of an iodopropargyl compound, thiabendazole, sodium pentachlorophenol, 1,2-benzisothiazolin-3-one, 2,3,5,6-tetrachloro-4 (methylsulfonyl)pyridine, paraoxybenzoic acid ester (ester of ethyl, methyl, propyl, isopropyl, butyl, isobutyl, or the like), phenol, sodium benzoate, sodium dehydroacetate, potassium sorbate, morpholine, cresol, methylisothiazolinone, chloromethylisothiazolinone, octylisothiazolinone, dichlorooctylisothiazolinone, hexahydro-1,3,5-tris(2-hydroxyethyl)-1,3,5-triazine, 2-bromo-2-nitropropane-1,3-diol, sodium 2-pyridinethiol-1-oxide, sodium pyrithione, 2-(4-thiozolyl)benzimidazole, 4-terpineol, 1,8-cineol, thymol, diisothiocyanate, eucalyptus oil, longifolene, isopropylmethylphenol, 2-methyl-4-isothiazolin-3-one, citral, eugenol, allyl isothiocyanate, d-limonene, tannic acid, sodium benzoate, ethyl paraben, benzalkonium chloride, glyceryl caprylate, glycerin fatty acid ester, chlorphenesin, salicylic acid, ethyl paraoxybenzoate, butyl paraoxybenzoate, propyl paraoxybenzoate, methyl paraoxybenzoate, bisabolol, hinokitiol, phenylethyl alcohol, phenethyl alcohol, phenoxyethanol, butylparaben, propylparaben, benzalkonium chloride, and methyl paraben.

Examples of the iodopropargyl compound that can be used include at least one selected from 3-iodo-2-propynylpropylcarbamate, 3-iodo-2-propynylbutylcarbamate (IPBC), 3-iodo-2-propynyl-m-chlorophenylcarbamate, 3-iodo-2-propynylphenylcarbamate, 3-iodo-2-propynyl 2,4,5-trichlorophenylether, 3-iodo-2-propynyl4-chlorophenylformal (IPCF), di-(3-iodo-2-propynyl) hexyldicarbamate, 3-iodo-2-propynyloxyethanolethylcarbamate, 3-iodo-2-propynyloxyethanolphenylcarbamate, 3-iodo-2-propynylthioxothioethylcarbamate, 3-iodo-2-propynylcarbamic acid ester (IPC), N-iodopropargyloxycarbonylalanine, N-iodopropargyloxycarbonylalanine ethyl ester, 3-(3-iodopropargyl)benzoxazol-2-one, 3-(3-iodopropargyl)-6-chlorobenzoxazol-2-one, 3-iodo-2-propynylalcohol, 4-chlorophenyl 3-iodopropargylformal, 3-bromo-2,3-diiodo-2-propenylethylcarbamate, 3-iodo-2-propynyl-n-hexylcarbamate, 3-iodo-2-propynylcyclohexylcarbamate, and the like.

The antimicrobial components of the group A including these iodopropargyl compounds are compounds which are known in the related art and have high safety and antimicrobial and antifungal properties, a production method of each compound is also known, and the compounds can be prepared by various production methods. In addition, the commercially available products of the compounds included in the group A, if present, can be used.

In the present disclosure, from the viewpoint of further safety and stability, preferably, among the above iodopropargyl compounds, at least 3-iodo-2-propynyl butyl carbamate (hereinafter, sometimes simply referred to as “IPBC”) is preferably contained (IPBC alone or a mixture containing IPBC), and as a component other than the iodopropargyl compounds, at least one selected from thiabendazole, 2-bromo-2-nitropropane-1,3-diol, phenoxyethanol, 4-terpineol, 1,8-cineol, tannic acid, benzalkonium chloride, glycerin fatty acid ester, potassium sorbate, parabens (butyl paraben, propyl paraben, ethyl paraben, methyl paraben), chloromethylisothiazolinone, methylisothiazoline, and benzisothiazolinone is desirably used.

The (meth)acrylate monomer represented by the above general formula (I) used in the present disclosure is used from the viewpoint of strength of an antimicrobial component that can be encapsulated, ability to produce persistently stable particles, absence of adverse effects on other blended components, and high persistence of the effect.

R in the above general formula (I) represents a hydrogen atom (H), an alkyl group having 1 to 22 carbon atoms, or a substituent having a polyalkylene glycol chain in which the alkylene chain has 2 to 18 carbon atoms, and the alkyl group or the substituent having a polyalkylene glycol chain may have, as a substituent, a phenyl group, a benzyl group, an epoxy group, a hydroxyl group, a dialkylamino group, an alkoxy group having 1 to 18 carbon atoms, a perfluoroalkyl group having 1 to 18 carbon atoms, or a trialkoxysilyl group, and examples thereof include a linear or branched alkyl group having 1 to 20 carbon atoms, a cycloalkyl group having 3 to 10 carbon atoms, and an alkyl group having 1 to 18 carbon atoms which may have, as a substituent, an epoxy group, a hydroxyl group, a dialkylamino group, or an alkoxy group having 1 to 4 carbon atoms, and above all, an alkyl group having 1 to 6 carbon atoms which may have, as a substituent, an epoxy group, a hydroxyl group, or an alkoxyl group having 1 to 2 carbon atoms, and an alkyl group having 1 to 6 carbon atoms which may have, as a substituent, an epoxy group are exemplified.

Preferably, R in the above general formula (I) is a linear or branched alkyl group having 1 to 20 carbon atoms, a cycloalkyl group having 3 to 10 carbon atoms, a hydroxyl group, a trifluoroethyl group, a dimethylaminoethylgroup, a methoxyethyl group, a hydroxyethylgroup, a hydroxypropyl group, an allyl group, a tetrahydrofurfuryl group, a phenyl group, a benzyl group, a butoxydiethylene glycol group, a methoxypolyethylene glycol group, a dimethylaminoethyl group, a diethylaminoethyl group, a dimethylaminoethyl group, a glycidyl group, ethyl phosphate, 1,4-butanediol, 1,6-hexanediol, or 1,9-nonanediol. Note that the “(meth)acrylic acid” represents “acrylic acid and/or methacrylic acid”.

Specific examples of the (meth)acrylate to be used, represented by the above general formula (I), include at least one (each alone or two or more, the same applies hereinafter) of methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethylhexyl (meth)acrylate, lauryl (meth)acrylate, palmityl (meth)acrylate, stearyl (meth)acrylate, behenyl (meth)acrylate, cyclohexyl (meth)acrylate, phenyl (meth)acrylate, benzyl (meth)acrylate, isobornyl (meth)acrylate, glycidyl (meth)acrylate, tetrahydrofurfuryl (meth)acrylate, allyl (meth)acrylate, 2-hydroxyethyl (meth)acrylate, hydroxypropyl (meth)acrylate, 2-methoxyethyl (meth)acrylate, 2-ethoxyethyl (meth)acrylate, dimethylaminoethyl (meth)acrylate, dimethylaminoethyl (meth)acrylate methyl chloride, diethylaminoethyl (meth)acrylate, ethylene glycol di(meth)acrylate, triethylene glycol di(meth)acrylate, 1,3-butylene glycol di(meth)acrylate, 1,6-hexanediol di(meth)acrylate, trimethylolpropane tri(meth)acrylate, 2-(meth)acryloyloxyethyl phthalate, 2-(meth)acryloyloxyethyl hexahydrophthalate, trifluoroethyl (meth)acrylate, butoxyethyl (meth)acrylate, methoxytetraethylene glycol (meth)acrylate, 2-hydroxypropyl (meth)acrylate, 3-chloro-2-hydroxypropyl (meth)acrylate, 2-hydroxy-3-phenoxypropyl (meth)acrylate, diethylene glycol (meth)acrylate, 2-(dimethylamino)ethyl (meth)acrylate, 2-(dimethylamino)propyl, 2-(dimethylamino)butyl (meth)acrylate, 2-isocyanoethyl (meth)acrylate, 2-(acetoacetoxy)ethyl (meth)acrylate, perfluoroethylmethacrylate having perfluoroalkyl with1 to 18 carbon atoms, 2-(methacryloyloxy) ethyl phosphate, trialkoxysilylpropyl (meth)acrylate, dialkoxymethylsilylpropyl (meth)acrylate, and the like.

Among these, from the viewpoint of industrial availability, easy handling and safety at the time of production, and further improvement of the effect of the present disclosure, preferably, methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethylhexyl (meth)acrylate, and cyclohexyl (meth)acrylate are desired.

In the present disclosure, in addition to the (meth)acrylate monomer described above, from the viewpoint of obtaining a sustained antimicrobial effect, preferably, a hydrophobic vinyl monomer besides the (meth)acrylate monomer, and an aqueous monomer can be further used.

As the hydrophobic vinyl monomer, for example, at least one of monomers such as styrenes such as styrene and methyl styrene besides the (meth)acrylate monomer can be used.

Examples of the hydrophobic vinyl monomer that can be used include at least one of styrene, methyl styrene, chloromethyl styrene, alkyl styrene having an alkyl group with 1 to 12 carbon atoms, methoxy styrene, chlorostyrene, bromostyrene, divinylbenzene, phenyl styrene, vinyl naphthalene, or the like.

Examples of the aqueous monomer that can be used include at least one of glycerin monomethacrylate, sodium 2-sulfoethyl methacrylate, polyethylene glycol monomethacrylate, polypropylene glycol monomethacrylate, polyethylene glycol-polypropylene glycol monomethacrylate, polyethylene glycol-tetramethylene glycol-monomethacrylate, propylene glycol-polybutylene glycol-monomethacrylate, or the like.

The antimicrobial particle dispersion according to the present disclosure includes at least the (meth)acrylate monomer represented by the general formula (I) and at least one antimicrobial component selected from the group A. As the production method thereof, for example, an aqueous dispersion of antimicrobial particles is produced by dissolving the antimicrobial component of the group A in the (meth)acrylate monomer (each alone or two or more, the same applies hereinafter) or a monomer mixture of the (meth)acrylate monomer and another hydrophobic vinyl monomer and/or an aqueous monomer, and performing emulsion polymerization with a polymerization initiator such as ammonium persulfate, potassium persulfate, or hydrogen peroxide, and a polymerization initiator obtained by further using a reducing agent in combination therewith, and further using a crosslinking agent such as triallyl isocyanurate, isocyanuric acid triallyl, polyethylene glycol dimethacrylate, polypropylene glycol dimethacrylate, pentaerythritol acrylate, ditrimethylolpropane acrylate, dipentaerythritol acrylate, methoxylated bisphenol A methacrylate, pentaerythritol methacrylate, ditrimethylolpropane methacrylate, dipentaerythritol methacrylate, or ethoxylated polyglycerin methacrylate, and as needed, a polymerizable surfactant (emulsifier) such as ammonium polyoxyethylene-1-(allyloxymethyl)-alkyl ether sulfate, ether sulfate, ammonium polyoxyethylene nonylpropenylphenyl ether sulfate, polyoxyethylene nonylpropenylphenyl ether, ammonium polyacrylate, styrene-maleic acid copolymer ammonium, polyoxyethylene alkyl ether, polyoxyethylene styrenated phenyl ether, polyoxyethylene polyoxypropylene glycol, polyoxyalkylene decyl ether, polyoxyethylene tridecyl ether, alkyl benzene sulfonate, dioctyl sulfosuccinate, sodium lauryl sulfate, polyoxyethylene alkyl ether phosphoric ester, polyoxyethylene styrenated phenyl ether phosphoric ester, polyoxyethylene styrenated phenyl ether sulfate, polyoxyethylene alkyl ether sulfate, polyoxyethylene sorbitan monolaurate (polysorbate 20), polyoxyethylene sorbitan palmitate (polysorbate 40), polyoxyethylene sorbitan monostearate (polysorbate 60), or polyoxyethylene sorbitan oleate (polysorbate 80). Then, it is possible to obtain the antimicrobial particle dispersion by drying the produced aqueous dispersion

When the above-mentioned crosslinking agent such as triallyl isocyanurate is used, heat resistance, mechanical properties, hydrolysis resistance, and weather resistance of the antimicrobial particle dispersion can be improved, which is preferable.

In the emulsion polymerization described above in the present disclosure, a dicyclopenta (te) nyl (meth)acrylate monomer or the like may be further mixed with the above-mentioned (meth)acrylate monomer and the like in an appropriate amount to carry out the emulsion polymerization. With the polymer obtained by further mixing the dicyclopenta (te) nyl (meth)acrylate monomer followed by the emulsion polymerization, even when water in the aqueous dispersion is volatilized, the stability is less likely to be impaired, and an antimicrobial particle dispersion having superior stability can be obtained.

The dicyclopenta(te)nyl (meth)acrylate monomer that can be used includes dicyclopentanyl acrylate monomer, dicyclopentenyl acrylate, dicyclopentanyl methacrylate monomer, and dicyclopentenyl methacrylate.

Furthermore, in the emulsion polymerization described above in the present disclosure, in addition to the (meth)acrylate monomer, other hydrophobic vinyl monomers descried above, and the dicyclopenta(te)nyl (meth)acrylate monomer, monomers having a reactive crosslinking group such as an epoxy group, a hydroxymethylamide group, and an isocyanate group, or a polyfunctional monomer having two or more vinyl groups may be blended in an appropriate amount for crosslinking.

In the present disclosure, in the polymer components included in the antimicrobial particle dispersion, the (meth)acrylate monomer described above needs to be contained in an amount of 30 mass % or more relative to a total of polymer components in the antimicrobial particle dispersion, and is desired to be contained in an amount of preferably 30 to 95 mass %, and more preferably 30 to 70 mass %. Note that, in the present disclosure, the term “total of polymer components” refers to polymerizable components in the antimicrobial particle dispersion, and specifically, it refers to the total amount of the (meth)acrylate monomer used, the other monomer components used, and the crosslinking agent described below.

When the content of the (meth)acrylate monomer described above is 30 mass % or more based on the total of polymer components, the effect of the present disclosure can be exhibited, while less than 30 mass % of the content may impair the stability over time, which is not preferable.

Furthermore, in the polymer components constituting the antimicrobial particle dispersion, the content of the other monomer components other than the (meth)acrylate monomer is the remainder of the total amount of the (meth)acrylate monomer used and the crosslinking agent described below.

Preferably, the content of the other monomer components is desired to be 0.5 to 70 mass % based on the total of polymer components from the viewpoint of further exerting the effect of the present disclosure and of dispersibility and reactivity.

In the present disclosure, from the viewpoint of achieving sufficient antimicrobial performance, a sustained antimicrobial effect, stability, and the like, the content (solid content) of the antimicrobial component is desirably 1 mass % or more, preferably 5 mass % or greater, more preferably 10 to 50 mass %, and particularly preferably 15 to 40 mass %, based on the total of polymer components. When the content of the antimicrobial component is 1 mass % or more, sufficient antimicrobial performance (including an antifungal effect) and a sustained antimicrobial effect can be exhibited, while less than 1 mass % of the content of the antimicrobial component may result in insufficient antimicrobial performance, and as a result, the effect of the present disclosure cannot be exhibited.

The polymerizable surfactant that can be used as necessary is not particularly limited as long as it is normally used in the emulsion polymerization described above. The polymerizable surfactant is, for example, an anionic or nonionic polymerizable surfactant, and includes at least one of ADECA REASOAP NE-10, NE-20, NE-30, NE-40, and SE-10N available from ADECA Corporation, LATEMUL S-180, 5-180A, and S-120A available from Kao Corporation, ELEMINOL JS-20 available from Sanyo Chemical Industry Ltd., or AQUALON KH-10 available from DKS Co., Ltd. The amount of the polymerizable surfactant to be used is preferably 0 to 50 mass %, and more preferably 0.1 to 50 mass %, based on the total amount of the monomers.

Further, it is desired that the content of the crosslinking agent such as triallyl isocyanurate described above is 0 to 50 mass %, and preferably 0.1 to 25 mass % based on the total amount of the above-mentioned monomers.

In the present disclosure, the antimicrobial particle dispersion (aqueous dispersion) in which antimicrobial particles are dispersed in water is obtained by the preferred aspect described above, specifically, by dissolving at least the antimicrobial component selected from the group A described above in the (meth)acrylate monomer and performing emulsion polymerization, or by dissolving the antimicrobial component at least after polymerization of the monomer mixture containing the (meth)acrylate monomer and the other monomer components and performing emulsion polymerization. The production amount of the antimicrobial particles in the antimicrobial particle dispersion obtained under these production conditions varies depending on blending amounts of the (meth)acrylate monomer, the antimicrobial component, and the like to be used, the polymerization conditions, and the like. From the viewpoint of productivity, workability, efficiency, and the like, the antimicrobial particles are preferably produced to have a solid content of 1 to 50 mass %. More preferably, it is produced to have a solid content of 10 to 40 mass %. This antimicrobial particle dispersion (aqueous dispersion) becomes an antimicrobial particle dispersion which has strength and persistence of antimicrobial performance (including an antifungal effect), does not adversely affect other blended components and the like, and is excellent in stability by being made into the antimicrobial particle dispersion of the present disclosure, as compared with a case where the antimicrobial component is used alone. In particular, it is possible to obtain an antimicrobial particle dispersion which can maintain or improve the antimicrobial effect (including an antifungal effect) of the antimicrobial component even after a long period of time.

In addition, in the present disclosure, as an oil-soluble (lipophilic) preservative component is preferably used as the antimicrobial component, in particular, there is a problem that the antimicrobial component is likely to adhere to a plastic container, thereby the antimicrobial effect including an antiseptic power get impaired over time. In order to solve the problem, the antimicrobial component is encapsulated in the particles composed of the (meth)acrylic acid component and the like of the present disclosure so as to suppress adhesion to the container wall surface, thereby achieving a specific effect that the antimicrobial effect can be maintained over a long period of time.

In the present disclosure, an average particle size of the antimicrobial particles in the resulting antimicrobial particle dispersion varies depending on the (meth)acrylate monomer, the type of the other monomers to be used, the contents, the polymerization conditions in the polymerization, and the like. The average particle size of the antimicrobial particles is preferably 10 to 800 nm, more preferably 20 to 300 nm, and even more preferably 30 to 200 nm. When the average particle size is within the preferred range described above, the antimicrobial particle dispersion is excellent in storage stability. The antimicrobial particles having an average particle suitable for various applications described below can be used. In a case where the antimicrobial particle dispersion is used for an aqueous ink for awriting instrument, apen feedof awriting instrument such as a felt-tip pen, amarking pen, or a ballpoint penis not clogged, and further, excellent storage stability is exhibited.

Note that the “average particle size” prescribed in the present disclosure is a histogram average particle size based on scattered light intensity distribution and, in the present disclosure (including Examples described below), is a value of D50 measured by using a particle size distribution measuring equipment [FPAR1000 (available from Otsuka Electronics Co., Ltd.)].

In the antimicrobial particle dispersion of the present disclosure, the content of the antimicrobial particles contained in the dispersion is preferably 0.1 to 50 mass %, more preferably 1 to 30 mass %, in terms of solid content, depending on each application described below. When the content of the antimicrobial particles is less than 0.1 mass % in terms of solid content, the effect of the present disclosure cannot be exhibited. On the other hand, when the content of the antimicrobial particles exceeds 50 mass %, long-term storage stability tends to decrease.

The antimicrobial particle aqueous dispersion of the present disclosure configured as described above can be used to impart antimicrobial properties to various products such as medical devices, baby products, nursing products, bath products, kitchen utensils, tableware, drinking water piping parts, daily hygiene products, household electrical appliances, clothing, building materials, agricultural materials, automobile interior parts, stationery, and ink compositions for writing instruments and inkjet printers. In addition to the above-described applications, as specific applications, the antimicrobial particle dispersion can be suitably used for detergents such as a laundry detergent, a softener, a household detergent, a dish detergent, and a detergent for a hard surface; personal care applications such as a shampoo, a rinse, a skin lotion, a milky lotion, a cream, a sunscreen, a foundation, an eye makeup product, an antiperspirant, and a toothpaste; industrial water treatment applications such as a boiler, cooling equipment, waste water treatment equipment, and industrial water (papermaking process water in a papermaking process, cooling water and washing water for various industries); a medical instrument, a food additive, and electronic devices such as a solar cell module, an organic device, and a heat-ray shielding film; and a water tank and a chemical bath for suppressing water molds on aquatic organisms (such as fish). The antimicrobial particle aqueous dispersion of the present disclosure has high stability and safety, is excellent in the antimicrobial effect (including an antifungal effect) of the antimicrobial component after a long period of time, and does not affect other blended components. Thus, as described above, the antimicrobial particle aqueous dispersion can be used to impart antimicrobial properties to various products, and in particular, can be suitably used in detergent applications, personal care applications, industrial water treatment applications, food additives, electronic device applications, and water tank and chemical bath applications as water mold suppression for aquatic organisms (such as fish). For example, hereinafter, a case where the antimicrobial particle aqueous dispersion is used for an aqueous ink composition for a writing instrument.

The aqueous ink composition for a writing instrument according to the present disclosure contains at least the antimicrobial particle dispersion having the above-described configuration, and can contain a colorant and a water-soluble organic solvent in addition to the antimicrobial particle dispersion.

The content of the antimicrobial particles in the ink composition is preferably 0.1 to 30.0 mass %, more preferably 1.0 to 15.0 mass % in terms of solid content with respect to the total amount of the ink composition, from the viewpoint of exhibiting the effect of the present disclosure without impairing writing performance and from the viewpoint of storage stability.

As the colorant that can be used, for example, a water-soluble dye, a pigment such as an inorganic pigment, an organic pigment, a plastic pigment, hollow resin particles having voids within the particles that are used as a white pigment, resin particles (pseudo-pigment) dyed with a dye having excellent color development and dispersibility, a thermochromic pigment, a photochromic pigment, or the like can be used.

For the water-soluble dye, a direct dye, an acid dye, an edible dye, or a basic dye can be used in an appropriate amount within a range in which the effects of the present disclosure would not be impaired. The content of the colorant varies depending on the type of the writing instrument, and the like, and is 1 to 30 mass % with respect to the total amount of the ink composition.

The water-soluble organic solvent that can be used includes, for example, at least one of alkylene glycols such as ethylene glycol, triethylene glycol, tetraethylene glycol, propylene glycol, dipropylene glycol, 1,2-propanediol, 1,3-propanediol, 1,2-butanediol, 2,3-butanediol, 1,3-butanediol, 1,4-butanediol, 1,2-pentanediol, 1,5-pentanediol, 2,5-hexanediol, 3-methyl-1,3-butanediol, 2-methylpentane-2,4-diol, 3-methylpentane-1,3,5-triol, and 1,2,3-hexanetriol; polyalkylene glycols such as polyethylene glycol and polypropylene glycol; glycerols such as glycerol, diglycerol, and triglycerol; lower alkyl ethers of glycols such as ethylene glycol monomethyl ether, ethylene glycol monoethyl ether, diethylene glycol monomethyl ether, diethylene glycol monoethyl ether, and diethylene glycol mono-n-butyl ether; N-methyl-2-pyrrolidone, or 1,3-dimethyl-2-imidalizinone.

In addition, water-soluble solvents such as alcohols such as methyl alcohol, ethyl alcohol, isopropyl alcohol, n-butyl alcohol, tert-butyl alcohol, isobutyl alcohol, hexyl alcohol, octyl alcohol, nonyl alcohol, decyl alcohol, benzyl alcohol, and amides such as dimethylformamide and diethylacetamide, and ketones such as acetone may also be mixed.

The content of these water-soluble organic solvents varies depending on the kind of writing instruments such as felt-tip pens, marking pens, and ballpoint pens, and is 1 to 40 mass % based on the total amount of the ink composition. The ink composition in which the content of the solvent is 10 mass % or less is particularly effective in terms of further improving a drying property of the drawn lines, and it is desired that the content is more preferably 3 to 8 mass %.

Besides the particles having the characteristics described above, the colorant, and the water-soluble solvent, the aqueous ink composition for a writing instrument of the present disclosure can appropriately contain, as the balance, water as a solvent (e.g., tap water, purified water, distilled water, ion exchanged water, or pure water) as well as a dispersant, a lubricant, a pH adjuster, a corrosion inhibitor, a thickener, an evaporation inhibitor, a surfactant, or the like, within a range in which the effects of the present disclosure are not be impaired.

Examples of the dispersant that can be used include nonionic and anionic surfactants, and water-soluble resins. Preferably, water-soluble polymers are used.

Examples of the lubricant include, but are not limited to, non-ionic types such as fatty acid esters of polyhydric alcohols, higher fatty acid esters of sugars, polyoxyalkylene higher fatty acid esters, and alkyl phosphate esters; anionic types such as alkyl sulfonates of higher fatty acid amides and alkyl allyl sulfonates; derivatives of polyalkylene glycols, fluorochemical surfactants, and polyether modified silicones, which are also used as surface treating agents for pigments.

Examples of the pH adjuster include ammonia, urea, monoethanolamine, diethanolamine, triethanolamine, alkali metal salts of carbonic acid and phosphoric acid such as sodium tripolyphosphate and sodium carbonate, and alkali metal hydroxides such as sodium hydroxide. Examples of the corrosion inhibitor include benzotriazole, tolyltriazole, dicyclohexylammonium nitrite, and saponins. Examples of the thickener include carboxymethylcellulose (CMC) or salts thereof, fermented cellulose, crystalline cellulose, and polysaccharides. Examples of the polysaccharides that can be used include xanthan gum, guar gum, hydroxypropylated guar gum, casein, gumarabic, gelatin, amylose, agarose, agaropectin, arabinan, curdlan, callose, carboxymethyl starch, chitin, chitosan, quince seed, glucomannan, gellan gum, tamarind seed gum, dextran, nigeran, hyaluronic acid, pustulan, furoran, HM pectin, porphyran, laminaran, lichenan, carrageenan, alginic acid, tragacanth gum, alkasy gum, succinoglycan, locust bean gum, and tara gum. These polysaccharides may be used alone, or two or more thereof may be used in combination. Commercially available products of these, if present, can be used. Examples of the vaporization inhibitor include pentaerythritol, p-xylene glycol, trimethylolpropane, triethylolpropane, and dextrin.

Examples of the surfactant include fluorine-based, silicone-based, and acetylene glycol-based surfactants.

The aqueous ink composition for a writing instrument of the present disclosure can be prepared by appropriately combining the antimicrobial particle dispersion having the characteristics described above, the water-soluble solvent, and other components, depending on the application of the aqueous ink composition for a writing instrument (e.g., for a ballpoint pen, a marking pen), and then mixing those by stirring using a stirrer such as a homomixer, a homogenizer, or a disperser, and, as necessary, further filtering or centrifuging the mixture to remove coarse particles in the ink composition.

In addition, a pH level of the aqueous ink composition for writing instruments of the present disclosure (at 25° C.) is adjusted to preferably 5 to 10, further preferably 6 to 9.5, by using a pH adjuster or the like from the perspective of usability, safety, stability of the ink itself, and matching with the ink container.

The aqueous ink composition for writing instruments of the present disclosure is loaded in a ballpoint pen, a marking pen, or the like provided with a pen tip such as a ballpoint pen tip, a fiber tip, a felt tip, or a plastic tip.

The ballpoint pen includes an instrument where the aqueous ink composition for writing instruments having the above-mentioned composition is accommodated in an ink container (refill) for a ballpoint pen having a ball with a diameter of 0.18 mm to 2.0 mm, and where a material which is not compatible with the aqueous ink composition accommodated in the ink container and which has a small specific gravity with respect to the aqueous ink composition, for example, polybutene, silicone oil, and mineral oil is accommodated as an ink follower.

Note that the structures of the ballpoint pen and the marking pen are not particularly limited, and the ballpoint pen and the marking pen may be, for example, a direct liquid type pen provided with a collector structure (ink holding mechanism) using a shaft cylinder itself as an ink container in which the shaft cylinder is filled with the aqueous ink composition for writing instruments having the configuration described above.

In the aqueous ink composition for a writing instrument of the present disclosure configured as described above, the antimicrobial particle dispersion having the characteristics described above is blended in the aqueous ink composition for a writing instrument. Thus, the antimicrobial particles have the strength and persistence of the antimicrobial performance (including the antifungal effect) in the ink composition without adversely affecting other blended components or the like, and the persistent effect is maintained for a long period of time. In addition, these particles do not impair the storage stability and the writing performance, which can further enhance a degree of freedom in ink design. Accordingly, it is possible to obtain an aqueous ink composition for a writing instrument suitable for writing instruments such as a ballpoint pen and a marking pen.

The case where the antimicrobial particle aqueous dispersion of the present disclosure is used for the aqueous ink composition for a writing instrument has been described above. The antimicrobial particle aqueous dispersion of the present disclosure is excellent in antimicrobial effect (including an antifungal effect) of the antimicrobial component even after a long period of time, has high safety, has a wide antibacterial spectrum by selecting the antimicrobial component to be used, does not adversely affect other blended components, has excellent stability, and can be used at a blending proportion suitable for the detergent application, personal care application, industrial water treatment application, food additive application, electronic device application, and water tank and chemical bath application as water mold suppression for aquatic organisms (such as fish).

### EXAMPLES

Next, the present disclosure will be described in more detail using Examples and Comparative Examples, but the present disclosure is not limited to the following Examples.

### Examples 1 to 9: Production of Antimicrobial Particle Dispersions (Particles 1 to 9)

Antimicrobial particle dispersions were produced by the following Examples 1 to 9. Note that the term “parts” below refers to parts by mass. The parts of antimicrobial component is based on a solid content.

### Example 1

A 2-liter flask equipped with a stirrer, a reflux condenser, a thermometer, a nitrogen gas-inlet, and a 1000 mL separating funnel for addition of a monomer was set in a hot water bath, and charged with 329.5 parts of distilled water, 5 parts of glycerin monomethacrylate [BLEMMER GLM, available from NOF Corporation], 5 parts of sodium 2-sulfoethyl methacrylate [acrylic ester SEM-Na, available from Mitsubishi Chemical Corporation], 20 parts of a polymerizable surfactant [ADEKA REASOAP SE-10N, available from ADEKA Corporation, ether sulfate], and 0.5 parts of ammonium persulfate, and the internal temperature was increased to 50° C. while nitrogen gas was introduced.

On the other hand, 20 parts of an antimicrobial component [iodopropargyl compound: 3-iodo-2-propynylcarbamate, “Omacide IPBC 100” available from LONZA K.K.], 14 parts of tannin [“Tannic acid S” available from Fuji Chemical Industries, Co., Ltd.], and 10 parts of a crosslinking agent [triallyl isocyanurate, “TAIC” available from Nippon Kasei Chemical Company Limited] were mixed with a monomer mixture including 55 parts of cyclohexyl methacrylate monomer and 20 parts of n-butyl methacrylate to prepare a solution.

The prepared solution was added to the flask maintained at a temperature of about 50° C. from the separatory funnel over 3 hours with stirring to carry out emulsion polymerization. Further, the solution was aged for 5 hours to terminate the polymerization, and thus an antimicrobial particle dispersion (aqueous dispersion) (particles 1) was obtained.

The content of the methacrylate monomer was 50.0 mass % based on the total of polymer components constituting the antimicrobial particles, and the content of the antimicrobial component was 36.2 mass % based on the total of polymer components. The antimicrobial particles had an average particle size of 56 nm.

### Example 2

An antimicrobial particle dispersion (aqueous dispersion) (particles 2) was obtained in the same manner as in Example 1 except that in Example 1, 340.5 parts of distilled water was used, the amount of cyclohexyl methacrylate monomer was 30 parts, the amount of n-butyl methacrylate was 45 parts, and 30 parts of an antimicrobial component [iodopropargyl compound: 3-iodo-2-propynylcarbamate, “Omacide IPBC 100” available from LONZA K.K.] was used as the antimicrobial component.

The content of the methacrylate monomer was 37.5 mass % based on the total of polymer components constituting the antimicrobial particles, and the content of the antimicrobial component was 46.2 mass % based on the total of polymer components. The antimicrobial particles had an average particle size of 73 nm.

### Example 3

An antimicrobial particle dispersion (aqueous dispersion) (particles 3) was obtained in the same manner as in Example 1 described above, except that in Example 1 described above, 309.5 parts of distilled water was used, the amount of cyclohexyl methacrylate monomer was 60 parts, the amount of n-butyl methacrylate was 35 parts, and 30 parts of an antimicrobial component [phenoxyethanol, available from Yokkaichi Chemical, Co., Ltd.] was used as the antimicrobial component.

The content of the methacrylate monomer was 35.1 mass % based on the total of polymer components constituting the antimicrobial particles, and the content of the antimicrobial component was 37.8 mass % based on the total of polymer components. The antimicrobial particles had an average particle size of 85 nm.

### Example 4

An antimicrobial particle dispersion (aqueous dispersion) (particles 4) was obtained in the same manner as in Example 1 described above, except that in Example 1 described above, 340.5 parts of distilled water was used, the amount of cyclohexyl methacrylate monomer was 30 parts, the amount of n-butyl methacrylate was 45 parts, and 40 parts of an antimicrobial component [paraben, available from Ueno Fine Chemicals Industry, Ltd.] was used as the antimicrobial component. The content of the methacrylate monomer was 49.3 mass % based on the total of polymer components constituting the antimicrobial particles, and the content of the antimicrobial component was 35.3 mass % based on the total of polymer components. The antimicrobial particles had an average particle size of 83 nm.

### Example 5

An antimicrobial particle dispersion (aqueous dispersion) (particles 5) was obtained in the same manner as in Example 1 except that in Example 1, 340.5 parts of distilled water was used, the amount of cyclohexyl methacrylate monomer was 30 parts, the amount of n-butyl methacrylate was 45 parts, and 15 parts of an antimicrobial component [chloromethylisothiazolinone/methylisothiazoline (CMIT/MIT) available from DAIWA CHEMICAL INDUSTRIES, Co., Ltd.] was used as the antimicrobial component.

The content of the methacrylate monomer was 33.2 mass % based on the total of polymer components constituting the antimicrobial particles, and the content of the antimicrobial component was 38.9 mass % based on the total of polymer components. The antimicrobial particles had an average particle size of 78 nm.

### Example 6

An antimicrobial particle dispersion (aqueous dispersion) (particles 6) was obtained in the same manner as in Example 1 described above, except that in Example 1 described above, 340.5 parts of distilled water was used, the amount of cyclohexyl methacrylate monomer was 30 parts, the amount of n-butyl methacrylate was 45 parts, 30 parts of an antimicrobial component [benzisothiazolinone (BIT), available from DAIWA CHEMICAL INDUSTRIES, Co., Ltd.] was used as the antimicrobial component.

The content of the methacrylate monomer was 31.6 mass % based on the total of polymer components constituting the antimicrobial particles, and the content of the antimicrobial component was 47.9 mass % based on the total of polymer components. The antimicrobial particles had an average particle size of 100 nm.

### Example 7

An antimicrobial particle dispersion (aqueous dispersion) (particles 7) was obtained in the same manner as in Example 1 described above, except that in Example 1 described above, 340.5 parts of distilled water was used, the amount of cyclohexyl methacrylate monomer was 30 parts, the amount of n-butyl methacrylate was 45 parts, and 25 parts of an antimicrobial component [methylisothiazoline (MIT), available from DAIWA CHEMICAL INDUSTRIES, Co., Ltd.] was used as the antimicrobial component.

The content of the methacrylate monomer was 31.6 mass % based on the total of polymer components constituting the antimicrobial particles, and the content of the antimicrobial component was 47.9 mass % based on the total of polymer components. The antimicrobial particles had an average particle size of 90 nm.

### Example 8

An antimicrobial particle dispersion (aqueous dispersion) (particles 8) was obtained in the same manner as in Example 1 described above, except that in Example 1 described above, 340.0 parts of distilled water was used, the amount of cyclohexyl methacrylate monomer was 30 parts, the amount of n-butyl methacrylate was 45 parts, and 25 parts of an antimicrobial component [thiabendazole, MOLDBAN-TZ, available from Mitsui Bussan Chemicals, Co., Ltd.] was used as the antimicrobial component.

The content of the methacrylate monomer was 28.9 mass % based on the total of polymer components constituting the antimicrobial particles, and the content of the antimicrobial component was 48.3 mass % based on the total of polymer components. The antimicrobial particles had an average particle size of 87 nm.

### Example 9

An antimicrobial particle dispersion (aqueous dispersion) (particles 9) was obtained in the same manner as in Example 1 described above, except that in Example 1 described above, 345.0 parts of distilled water was used, the amount of cyclohexyl methacrylate monomer was 45 parts, the amount of n-butyl methacrylate was 30 parts, and 30 parts of an antimicrobial component [2-bromo-2-nitropropane-1,3-diol, MOLDBAN-BNP, available from Mitsui Bussan Chemicals, Co., Ltd.] was used as the antimicrobial component.

The content of the methacrylate monomer was 29.3 mass % based on the total of polymer components constituting the antimicrobial particles, and the content of the antimicrobial component was 45.1 mass % based on the total of polymer components. The antimicrobial particles had an average particle size of 98 nm.

### Comparative Examples 1 to 3

Antimicrobial component-containing aqueous dispersions that were prepared to each have a content of the antimicrobial component before forming particles of 15 mass % without using the respective antimicrobial particles, for the respective antimicrobial particle aqueous dispersions B, C, and D of Examples 2, 3, and 4.

The obtained antimicrobial particle aqueous dispersions of Examples 1 to 9 and Comparative Examples 1 to 3 were evaluated for antimicrobial effects (bacterial flora, yeast, and filamentous fungus) by the following evaluation method.

The respective antimicrobial particle dispersions (aqueous dispersions) obtained in Examples 1 to 9 were used. The solid contents of the antimicrobial particles in the respective antimicrobial particle dispersions obtained in Examples 1 to 7 were 35 to 40 mass %. The obtained antimicrobial particle aqueous dispersions of Examples 1 to 9 and Comparative Examples 1 to 3 were evaluated for antimicrobial effects (bacterial flora, yeast, and filamentous fungus) at the initial stage and after 3 months at 40° C. by the following evaluation method.

These results are shown in Table 1 below.

### [Test Method for Antimicrobial Effects (Antimicrobial and Antifungal Properties)]

Evaluation was performed by the following microbial testing method in accordance with ISO 11930:2012 (Procedure for Interpretation of Data Generated by Preservative Efficacy Testing or Microbiological Risk Assessment, or both).

The challenge test was performed by using the three groups including the bacterial flora, the yeast, and the filamentous fungus described below.

Bacterial flora: Stapylococcus aureus NBRC13276, Escherichia coli NBRC3972

Yeast: Candida albicans NBRC1594

Filamentous fungus: Aspergillus brasiliensis

### Preparation of Inocula

Preparation of inoculum: Bacterial cultures were prepared in accordance with ISO 11930:2012.

Bacterial flora: Each bacterial culture was prepared in accordance with ISO 11930:2012 for each bacterial strain. Three types of the bacterial cultures, each of which has its bacterial strain adjusted to 1×10⁷ to 1×10⁸ cfu/mL, were mixed using equal amounts, and thus an inoculum was prepared.

Yeast: In accordance with ISO 11930:2012, a bacterial culture was prepared to be 1×10⁶ to 1×10⁷ cfu/mL.

Filamentous fungus: In accordance with ISO 11930:2012, a bacterial culture was prepared to be 1×10⁶ to 1×10⁷ cfu/mL.

### Inoculation

For each of the antimicrobial particle aqueous dispersion, 1 mass % of a bacterial culture was inoculated.

### Storage

The inoculated antimicrobial particle aqueous dispersion was stored at temperature of 22.5±2.5° C., andwas observed for a designated period of time by detection culture.

### Detection Culture

A total of 1 g was coated on 10 sheets of SCD agar media for the bacterial flora, SD agar media for the yeast, and PD agar media for the filamentous fungus, and the bacterial flora and the yeast were cultured at 32.5° C. for 2 days, and the filamentous fungus was cultured for 22.5° C. for 5 days.

Antimicrobial effect after 3 months at 40° C.

Each of the obtained antimicrobial particle aqueous dispersions of Examples 1 to 9 and Comparative Examples 1 to 3 was filled in a bottle with a polyethylene lid in an amount of 60 ml, sealed, and stored for 3 months under the condition of 40° C. Then, each of the aqueous dispersions was subjected to the above-described antimicrobial effects (antimicrobial and antifungal properties) and evaluated on the basis of the following evaluation criteria.

### Evaluation Criteria

A-1: No colony emerged at day 7.
A-2: No colony emerged at day 21.
B-1: Several to tens of colonies emerged at day 28.
B-2: Obvious increase was observed at day 28.

TABLE 1

| | | Examples | | | | | | | | | Comparative Examples | | |
|---|---|---|---|---|---|---|---|---|---|---|---|---|---|
| | | 1 | 2 | 3 | 4 | 5 | 6 | 7 | 8 | 9 | 1 | 2 | 3 |
| Comparison of Comparative | | — | — | — | — | — | — | — | — | — | Example 2 | Example 3 | Example 4 |
| Examples 1 to 3 with Examples | | | | | | | | | | | | | |
| Average particle size (nm) | | 56 | 73 | 85 | 83 | 78 | 100 | 90 | 87 | 98 | — | — | — |
| Initial | Bacterial flora | A-1 | B-2 | B-2 | B-2 | A-1 | A-1 | A-1 | A-1 | A-1 | B-2 | B-2 | B-2 |
| Evaluation | Yeast | A-1 | A-1 | A-2 | A-2 | A-1 | A-1 | A-1 | A-1 | A-1 | A-1 | A-2 | A-2 |
| | Filamentous | A-1 | A-1 | A-2 | A-2 | A-1 | A-1 | A-1 | A-1 | A-1 | A-1 | A-2 | A-2 |
| | fungus | | | | | | | | | | | | |
| Evaluation | Bacterial flora | A-1 | B-2 | B-2 | B-2 | A-1 | A-1 | A-1 | A-1 | A-1 | B-2 | B-2 | B-2 |
| after 3 months | Yeast | A-1 | A-1 | A-2 | A-2 | A-1 | A-1 | A-1 | A-1 | A-1 | B-2 | B-2 | B-2 |
| at 40° C. | Filamentous | A-1 | A-1 | A-2 | A-2 | A-1 | A-1 | A-1 | A-1 | A-1 | B-2 | B-2 | B-2 |
| | fungus | | | | | | | | | | | | |

From Table 1 above, it was found that Examples 1 to 9 within the scope of the present disclosure had excellent antimicrobial effects (including an antifungal effect) against bacterial flora, yeasts, filamentous fungi, and bacteria (Escherichia coli, Staphylococcus aureus) which are contamination sources at the initial stage and also after a long period of time (at 40° C., after 3 months), and had high safety and excellent stability. Furthermore, for each of the antimicrobial particle aqueous dispersions of Examples 1 to 9, when sensory evaluation was visually performed for aggregates and the like after storage at 26° C. for 3 months, no aggregate was found, and it was found that there were no problems in storage stability.

### Examples 10 to 18 and Comparative Examples 4 to 6: Preparation of Aqueous Ink Composition for Writing Instrument

For Examples 10 to 18, aqueous ink compositions for a writing instrument were prepared by a common method using the antimicrobial particle dispersions obtained in Examples 1 to 9 and the antimicrobial particle dispersions of Comparative Examples 1 to 3 (IPBC, phenoxyethanol, and paraben) with the following formulation (total amount: 100 mass %).

Ink composition (Total amount: 100 mass %)

### Antimicrobial Particle Dispersions (Examples 1 to 7) or Antimicrobial Dispersions of Comparative Examples 1 to 3

15.0 mass %

Colorant (carbon black MA100, available from Mitsubishi Chemical Corporation) 5.4 mass %

pH modifier (triethanolamine) 1.4 mass %

Water-soluble organic solvent (ethylene glycol) 15.0 mass %

Ion exchanged water 63.2 mass %

The obtained aqueous ink compositions for a writing instrument (total amount: 100 mass %) were evaluated for writing performance (vertical line density difference), stability, and antimicrobial effects (antimicrobial and antifungal properties) according to the following evaluation method.

Table 2 below shows the evaluation results of Examples 10 to 18 and Comparative Examples 4 to 6.

Preparation of Writing Instrument: Ballpoint Pen Using a shaft of a ballpoint pen (trade name: Signo UM-100, available from Mitsubishi Pencil Co., Ltd.), a refill composed of an ink storage tube made of polypropylene having an inner diameter of 4.0 mm and a length of 113 mm, a stainless steel tip (cemented carbide ball, ball diameter: 0.5 mm) and a joint connecting the storage tube and the tip was filled with the aqueous ink compositions described above, and an ink follower consisting mainly of a mineral oil was inserted at the rear end of the ink, thus preparing an aqueous ballpoint pen.

Method for evaluating writing performance (vertical line density difference)

Each aqueous ballpoint pen having the above-described configuration was left to stand at room temperature (25° C., the same applies hereinafter) for one month, and then writing was performed up to the end, and the difference in density of the drawn line at the start of writing and at the end of writing was compared and evaluated according to the following evaluation criteria.

Evaluation criteria:
A: No difference in density is observed.
B: A slight difference in density is observed.
C: A difference in density is clearly observed.
D: A difference in density is remarkable, and a portion where the drawn line is hardly visible is observed.

### Method for Evaluating Stability

After each of the ballpoint pens having the above-described configurations was stored for 3 months under the condition of 50° C. with the pen tip facing downward, the state of each ink was visually confirmed and evaluated according to the following criteria.

Evaluation criteria:
A: Neither separation nor aggregation occurs.
B: Slight separation or aggregation.
C: Separation or aggregation is observed.
D: Significant separation or aggregation is observed.

### [Test Method for Antimicrobial Effects (Antimicrobial and Antifungal Properties)]

Also for the aqueous ink compositions for a writing instrument of Examples 10 to 18 that fall within the scope of the present disclosure and Comparative Examples 4 to 6 that fall outside the scope of the present disclosure, the test was performed in accordance with the test method for antimicrobial effects (antimicrobial and antifungal properties) performed with the above-described antimicrobial particle aqueous dispersion (by inoculating a bacterial liquid in an amount of 1 mass % with respect to the aqueous ink composition for a writing instrument).

TABLE 2

| | | Examples | | | | | | | | | Comparative Examples | | |
|---|---|---|---|---|---|---|---|---|---|---|---|---|---|
| | | 10 | 11 | 12 | 13 | 14 | 15 | 16 | 17 | 18 | 4 | 5 | 6 |
| Evaluation | Writing | A | A | A | A | A | A | A | A | A | A | B | B |
| | performance | | | | | | | | | | | | |
| | Stability | A | A | A | A | A | A | A | A | A | C | C | C |
| | Bacterial flora | A-1 | B-2 | B-2 | B-2 | A-1 | A-1 | A-1 | A-1 | A-1 | B-2 | B-2 | B-2 |
| | Yeast | A-1 | A-1 | A-2 | A-2 | A-1 | A-1 | A-1 | A-1 | A-1 | B-2 | B-2 | B-2 |
| | Filamentous fungus | A-1 | A-1 | A-2 | A-2 | A-1 | A-1 | A-1 | A-1 | A-1 | B-2 | B-2 | B-2 |

From Table 2, it was confirmed that Examples 10 to 18, which fall within the scope of the present disclosure, were superior to Comparative Examples 4 to 6, which fall outside the scope of the present disclosure, in writing performance (vertical line density difference) and stability, and did not adversely affect other blended components of the ink while keeping strength and persistence of antimicrobial performance.

It has been confirmed that the ballpoint pen prepared above does not cause blur or feathering, and has a sufficient drawn line density to give a sharp drawn line.

### INDUSTRIAL APPLICABILITY

The antimicrobial particle dispersion of the present disclosure can also be suitably used in detergent applications, personal care applications, industrial water treatment applications, food additives, electronic device applications, water tank and chemical bath applications as water mold suppression for aquatic organisms (such as fish).In addition, it is utilized as a blended component of an aqueous ink composition for a writing instrument that is suitable for writing instruments such as a felt-tip pen, a marking pen, and a ballpoint pen.

1. An antimicrobial particle dispersion, comprising: water; and
antimicrobial particles dispersed in the water,
wherein the antimicrobial particles comprise:
(i) a (meth)acrylate monomer of formula (I): 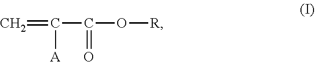
or CH₃, and R being H, an alkyl group having 1 to 22 carbon atoms, or an polyalkylene glycol chain substituent with an alkylene chain having to 18 carbon atoms, the alkyl group or the polyalkylene glycol chain substituent being optionally substituted by a benzyl group, an epoxy group, a hydroxyl group, a dialkylamino group, an alkoxy group having 1 to 18 carbon atoms, a perfluoroalkyl group having 1 to 18 carbon atoms, or a trialkoxysilyl group; and
(ii) an antimicrobial component comprising an iodopropargyl compound, thiabendazole, sodium pentachlorophenol, 1,2-benzisothiazolin-3-one, 2,3,5,6-tetrachloro-4(methylsulfonyl)pyridine, phenol, sodium benzoate, sodium dehydroacetate, potassium sorbate, morpholine, cresol, methylisothiazolinone, chloromethylisothiazolinone, octylisothiazolinone, dichlorooctylisothiazolinone, hexahydro-1,3,5-tris(2-hydroxyethyl)-1,3,5-triazine, 2-bromo-2-nitropropane-1,3-diol, sodium 2-pyridinethiol-1-oxide, sodium pyrithione, 2-(4-thiozolyl)benzimidazole, 4-terpineol, 1,8-cineol, thymol, diisothiocyanate, eucalyptus oil, longifolene, isopropylmethylphenol, 2-methyl-4-isothiazolin-3-one, citral, eugenol, allyl isothiocyanate, d-limonene, tannic acid, ethyl paraben, benzalkonium chloride, glyceryl caprylate, glycerin fatty acid ester, chlorphenesin, salicylic acid, ethyl paraoxybenzoate, butyl paraoxybenzoate, propyl paraoxybenzoate, methyl paraoxybenzoate, bisabolol, hinokitiol, phenylethyl alcohol, phenethyl alcohol, phenoxyethanol, butylparaben, propylparaben, benzalkonium chloride, methyl paraben, or a mixture thereof.

2. The dispersion of claim 1, wherein a content of the (meth)acrylate monomerr of formula (I) is in a range of from 30 to 95 mass %, based on a total polymer component mass of the antimicrobial particle dispersion.

3. The dispersion of claim 1, wherein a content of the antimicrobial component is 1 mass % or more, based on a total polymer component mass of the antimicrobial particles.

4. The dispersion of claim 1, wherein the antimicrobial particles in the antimicrobial particle dispersion have an average particle size in a range of from 10 to 800 nm.

5. The dispersion of claim 1, wherein a content of the antimicrobial particles is in a range of from 0.1 to 50 mass %, based on a total antimicrobial particle dispersion mass.

6. An aqueous ink composition suitable for a writing instrument, the composition comprising:
the antimicrobial particle dispersion of claim 1.

7. An aqueous ink composition suitable for a writing instrument, the composition comprising:
the antimicrobial particle dispersion of claim 2.

8. An aqueous ink composition suitable for a writing instrument, the composition comprising:
the antimicrobial particle dispersion of claim 3.

9. An aqueous ink composition suitable for a writing instrument, the composition comprising:
the antimicrobial particle dispersion of claim 4.

10. An aqueous ink composition suitable for a writing instrument, the composition comprising:
the antimicrobial particle dispersion of claim 5.

11. The dispersion of claim 1, wherein in the formula (I), R is the alkyl group the polyalkylene glycol chain substituent, and
wherein the alkyl group or the polyalkylene glycol chain substituent is substituted.

12. The dispersion of claim 1, wherein the (meth)acrylate monomer (i) comprises methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethylhexyl (meth)acrylate, cyclohexyl (meth)acrylate, or a mixture thereof.

13. The dispersion of claim 1, wherein the antimicrobial particles further comprise (iii) a hydrophobic vinyl monomer besides the (meth)acrylate monomer (i).

14. The dispersion of claim 13, wherein the hydrophobic vinyl monomer (iii) comprises styrene, methyl styrene, chloromethyl styrene, alkyl styrene having an alkyl group with 1 to 12 carbon atoms, methoxy styrene, chlorostyrene, bromostyrene, divinylbenzene, phenyl styrene, vinyl naphthalene, or a mixture thereof.

15. The dispersion of claim 1, wherein the antimicrobial particles further comprise (iv) an aqueous monomer.

16. The dispersion of claim 15, wherein the aqueous monomer (iv) comprises glycerin monomethacrylate, sodium 2-sulfoethyl methacrylate, polyethylene glycol monomethacrylate, polypropylene glycol monomethacrylate, polyethylene glycol-polypropylene glycol monomethacrylate, polyethylene glycol-tetramethylene glycol-monomethacrylate, propylene glycol-polybutylene glycol-monomethacrylate, or a mixture thereof.

17. The dispersion of claim 1, wherein the antimicrobial component (ii) comprises the iodopropargyl compound, and
wherein the iodopropargyl compound comprises 3-iodo-2-propynylpropylcarbamate, 3-iodo-2-propynylbutylcarbamate, 3-iodo-2-propynyl-m-chlorophenylcarbamate, 3-iodo-2-propynylphenylcarbamate, 3-iodo-2-propynyl 2,4,5-trichlorophenylether, 3-iodo-2-propynyl4-chlorophenylformal, di-(3-iodo-2-propynyl) hexyldicarbamate, 3-iodo-2-propynyloxyethanolethylcarbamate, 3-iodo-2-propynyloxyethanolphenylcarbamate, 3-iodo-2-propynylthioxothioethylcarbamate, 3-iodo-2-propynylcarbamic acid ester, N-iodopropargyloxycarbonylalanine, N-iodopropargyloxycarbonylalanine ethyl ester, 3-(3-iodopropargyl)benzoxazol-2-one, 3-(3-iodopropargyl)-6-chlorobenzoxazol-2-one, 3-iodo-2-propynylalcohol, 4-chlorophenyl 3-iodopropargylformal, 3-bromo-2,3-diiodo-2-propenylethylcarbamate, 3-iodo-2-propynyl-n-hexylcarbamate, 3-iodo-2-propynylcyclohexylcarbamate, or the mixture thereof.

18. The dispersion of claim 17, wherein the iodopropargyl compound comprises 3-iodo-2-propynyl butyl carbamate, and
wherein the antimicrobial component (ii) further comprises thiabendazole, 2-bromo-2-nitropropane-1,3-diol, phenoxyethanol, 4-terpineol, 1,8-cineol, tannic acid, benzalkonium chloride, glycerin fatty acid ester, potassium sorbate, parabens (butyl paraben, propyl paraben, ethyl paraben, methyl paraben), chloromethylisothiazolinone, methylisothiazoline, benzisothiazolinone, or the mixture thereof.
